(19) United States
(12) Patent Application Publication
(10) Pub. No.: US 2021/0194870 A1
(43) Pub. Date: Jun. 24, 2021

(54) PROCESSING DEVICE WITH TRUST/UNTRUST MODES

(71) Applicant: Seagate Technology LLC, Cupertino, CA (US)

(72) Inventors: Christopher Nicholas Allo, Lyons, CO (US); Benjamin T. Cordova, Longmont, CO (US)

(73) Assignee: Seagate Technology LLC

(21) Appl. No.: 16/719,288

(22) Filed: Dec. 18, 2019

(51) Int. Cl. H04L 29/06; G06F 15/78; G06F 3/06

(52) U.S. Cl. CPC H04L 63/0853; H04L 63/062; G06F 15/7807; G06F 3/067; G06F 3/0622; G06F 3/0653; G06F 3/0679

(57) ABSTRACT

Method and apparatus for implementing data security and privacy for a processing device. In some embodiments, the processing device is authenticated using a trusted authority. Self-authentication information is stored in a keystore of the processing device as a result of the authentication. The processing device subsequently operates in an untrusted mode by performing self-authentications using the self-authentication information in the keystore without further reference to the trusted authority. The trusted authority can be a remote server with which the processing device communicates over a network. The processing device can subsequently transition to a trust mode in which all authentications take place with the trusted authority without reference to the keystore. The processing device can be a data storage device such as a solid-state drive (SSD), a hard disc drive (HDD) or a hybrid drive (HDSD). The processing device can use untrust mode during manufacturing, and trust mode during field use.

### SUMMARY

Various embodiments of the present disclosure are generally directed to a method and apparatus for providing a processing device with different levels of device privacy and security under different operational conditions.

In some embodiments, the processing device is authenticated using a trusted authority. Self-authentication information is stored in a keystore of the processing device as a result of the authentication. The processing device subsequently operates in an untrusted mode by performing self-authentications using the self-authentication information in the keystore without further reference to the trusted authority.

These and other features and advantages which characterize the various embodiments of the present disclosure can be understood in view of the following detailed discussion and the accompanying drawings.

### BRIEF DESCRIPTION OF THE DRAWINGS

FIG. 1 provides a functional block representation of a processing device constructed and operated in accordance with various embodiments of the present disclosure.

FIG. 2 illustrates the device of FIG. 1 characterized as a solid-state drive (SSD) in accordance with some embodiments.

FIG. 3 shows the device of FIG. 1 characterized as a hard disc drive (HDD) or hybrid data storage device (HDSD) in further embodiments.

FIG. 4 is a schematic representation of a network utilizing data storage devices such as provided in FIGS. 1-3.

FIG. 5 shows a sequence diagram for an authentication process that can be carried out using a trusted authority such as a remote trusted server in some embodiments.

FIG. 6 is a functional representation of a manufacturing environment in which various devices under test (DUT) such as the storage devices of FIGS. 1-3 are subjected to manufacturing testing in some embodiments.

FIG. 7 is a simplified functional representation of another processing device constructed in accordance with some embodiments.

FIG. 8 shows an exemplary format for the keystore from FIG. 7 in some embodiments.

FIG. 9 is an untrust mode processing sequence carried out in accordance with some embodiments.

FIG. 10 is a trust mode processing sequence carried out in accordance with some embodiments.

FIG. 11 is a trust/untrust mode processing sequence that may be carried out in accordance with further embodiments.

FIG. 12 shows aspects of another processing device which implements different operational configurations during trust/untrust modes in some embodiments.

### DETAILED DESCRIPTION

The present disclosure generally relates to systems and methods for applying privacy and security techniques to processing devices, such as data storage devices.

It is often desirable for a processing device, such as a data storage device or other hardware based device, to operate in a trusted environment. A trusted environment is one in which the device has the capability of establishing trust within a grouping of itself with other devices, as well as the ability to discern and trust the other devices with which it communicates. A collection of devices among which a sufficient level of trust has been achieved is sometimes referred to as a “trust group,” and such a group can be said to operate within a “trust boundary.”

A variety of data security schemes have been proposed to establish trust among processing devices. These schemes often employ cryptographic security techniques to protect such systems from third party attacks. Some systems use a centralized trust-based security protocol to allow a particular host (client) device to gain access to a peripheral device, such as a data storage device or an array of data storage devices. The protocol may involve various steps carried out to respectively authenticate the host, to authenticate the storage device to a remote centralized server (such as a trusted security infrastructure or TSI server), and to authenticate the server to the host and the storage device.

Authentication can be carried out in a variety of ways such as through the use of encrypted challenge values, public and private encryption keys, hashes, digital signatures, biometric inputs, etc. Once the various entities have been mutually verified to each other, a secure operation can be carried out between the host and the peripheral device such as an access to a secured data storage volume, a change in device configuration, etc.

While operable, there are situations where it is not always necessary for a processing device to operate as a trusted device or within a trust boundary. That is, it is not always required that a device fully trust the inputs it is receiving, nor is it necessary that the output of the device be fully trusted without prior establishment of trust from the device to the target that receives the output.

One non-limiting example is during device manufacturing. During a typical manufacturing test sequence, a population of devices are subjected to a number of environmental conditions and operational routines to verify the devices function correctly prior to shipment. Under these circumstances, the testing protocol is carried out in a secure manufacturing environment where the physical communication interfaces with the devices are under control of a trusted environment (e.g., the manufacturer of the devices).

Some current test methodologies may load specially configured test firmware to enable the testing process, after which regular operational firmware is loaded to the device for field use. Regardless, the test firmware and normal firmware tend to use the same normal trust protocols to reestablish trust each time the device is rebooted, even though during the testing the device may be rebooted many times. If many thousands or even millions of devices are being concurrently tested at a time, the individual network communications required to establish and re-establish trust can become unwieldy and are unnecessary.

Various embodiments of the present disclosure are generally directed to an apparatus and method for operating a processing device, such as but not limited to a data storage device, in different trust modes. As explained below, a trusted mode may be a first operational level in which the device operates with a first, higher amount of trust, and an untrusted mode may be a second operational level in which the device operates with a second, lower amount of trust (including little or no trust at all). Multiple different levels may be provided as required, so it will be appreciated that the various embodiments presented herein are not limited to just two modes (e.g., trust/untrust modes).

Without limitation, some embodiments contemplate the use of an untrust mode during device manufacturing, after which the device is switched to a trust mode for the remainder of the device operational life. This is not necessarily limiting, however, as other alternatives are contemplated, including situations where the respective modes can be used under other forms of operational environments, situations where a particular device can be switched back and forth between the respective modes (once or many times), and so on.

In some embodiments, special test firmware is loaded to a selected device. The firmware is executed by a programmable processor of the device within a controlled environment, such as during manufacturing testing. The executed test firmware establishes a suitable level of trust for the device through communications with a trusted source, such as a remote server.

Once the suitable level of trust has been established, specially configured authentication information, referred herein as an authentication (auth) key and-self authentication information, is loaded to a local secure memory of the device (e.g., a keystore). Subsequent calls by the executed firmware to establish trust (such as after a reinitialization operation) result in the processor checking the contents of the keystore. If the correct information is present, the firmware proceeds with operation without separately reestablishing new trust with the remote authority.

Upon successful completion of the manufacturing testing, the final operational firmware is loaded to replace the test firmware. The final operational firmware is not configured to access or rely upon the keystore, so that subsequent calls for establishing trust are carried out in a conventional fashion (e.g., through communications with a remote trusted server, etc.).

In some embodiments, the keystore may be of the type that can only be written once and is afterwards physically altered once the manufacturing sequence has completed so that the keystore cannot be reused. An example is the use of OTP (one-time-programmable) elements as the keystore, so that all of the OTP elements can be irreversibly set to a selected level (e.g., open, etc.) once the device is ready for the operational firmware.

In other embodiments, the keystore may be of a volatile nature such that, upon a power down operation, reinitialization will require a new authentication process to reestablish trust with the device. In still other embodiments, the keystore may be non-volatile and rewritable as required to enable the device to be safely switched between different trust modes during operation. It is contemplated albeit not necessarily required that the keystore may form a portion of internal memory within a SOC (system on chip) integrated circuit device that cannot be normally accessed or sensed by a third party attacker.

The transition of a device between trust and untrust modes will tend to have certain consequences. In one case, the transition from trust to untrust mode can result in the destruction of existing encryption keys used to protect data stored by the device, so that so that any encrypted data stored on the device is immediately made inaccessible by the transition to untrust mode. Other system configurations can take place as well, such as certain volumes, regions, functions of the device, etc. being rendered inaccessible in a lower trust mode.

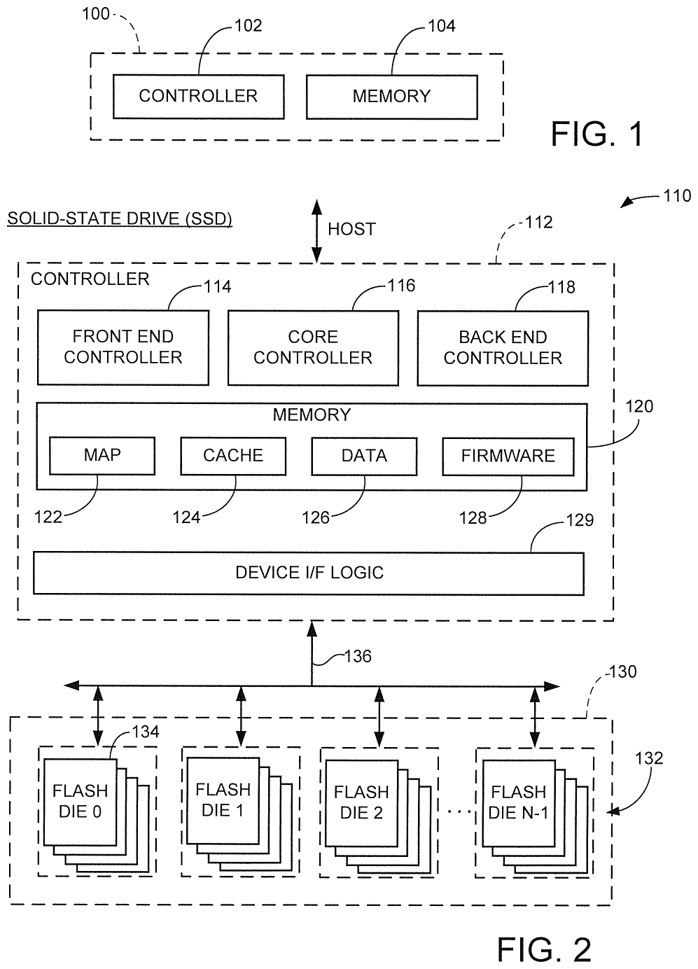

These and other features and advantages of various embodiments can be understood beginning with a review of FIG. 1 which shows a simplified functional block representation of a processing device 100. The processing device 100 is characterized as a data storage device, although other forms of processing devices can be used as desired.

The device 100 includes a controller circuit 102 which provides top-level control and communication functions as the device interacts with a host device (not shown) to store and retrieve host user data. A memory module 104 provides non-volatile storage of the data in the form of an array of flash memory cells.

The controller 102 may be a programmable CPU processor that operates in conjunction with programming stored in a computer memory within the device. The controller may alternatively be a hardware controller. The controller may be a separate circuit or the controller functionality may be incorporated directly into the memory array 104.

As used herein, the term controller and the like will be broadly understood as an integrated circuit (IC) device or a group of interconnected IC devices that utilize a number of fundamental circuit elements such as but not limited to transistors, diodes, capacitors, resistors, inductors, waveguides, circuit paths, planes, printed circuit boards, memory elements, etc. to provide a functional circuit regardless whether the circuit is programmable or not. The controller may be arranged as a system on chip (SOC) IC device, a programmable processor, a state machine, a hardware circuit, a portion of a read channel in a memory module, etc.

FIG. 2 shows an exemplary data storage device 110 corresponding to the device 100 of FIG. 1. The data storage device 110 is configured as a solid state drive (SSD) that communicates with one or more host devices via one or more Peripheral Component interface Express (PCIe) ports. The NVM is contemplated as comprising NAND flash memory, although other forms of solid state non-volatile memory can be used.

In at least some embodiments, the SSD operates in accordance with the NVMe (Non-Volatile Memory Express) specification, which enables different users to allocate NVM sets (die sets) for use in the storage of data. Each die set may form a portion of an NVMe namespace that may span multiple SSDs or be contained within a single SSD. Each namespace will be owned and controlled by a different user (host). While aspects of various embodiments are particularly applicable to devices operated in accordance with the NVMe specification, such is not necessarily required.

The SSD 110 includes a controller circuit 112 with a front end controller 114, a core controller 116 and a back end controller 118. The front end controller 114 performs host functions, the back end controller 118 directs data transfers with the memory module 114 and the core controller 116 provides top level control for the device.

Each controller 114, 116 and 118 includes a separate programmable processor with associated programming (e.g., firmware, FW) in a suitable memory location, as well as various hardware elements to execute data management and transfer functions. This is merely illustrative of one embodiment; in other embodiments, a single programmable processor (or less/more than three programmable processors) can be configured to carry out each of the front end, core and back end processes using associated FW in a suitable memory location. A pure hardware based controller configuration can alternatively be used. The various controllers may be integrated into a single system on chip (SOC) integrated circuit device, or may be distributed among various discrete devices as required.

A controller memory 120 represents various forms of volatile and/or non-volatile memory (e.g., SRAM, DDR DRAM, flash, etc.) utilized as local memory by the controller 112. Various data structures and data sets may be stored by the memory including one or more map structures 122, one or more caches 124 for map data and other control information, one or more data buffers 126 for the temporary storage of host (user) data during data transfers, and firmware (FW) 128 loaded to the memory for execution by the various processors of the controller 112.

At this point it will be appreciated that any number of additional elements, modules, blocks, circuits etc. can be incorporated into the controller and/or other portions of the SSD including, but not limited to, hardware accelerators, temperature and other forms of environmental sensors, compression/decompression blocks, error detection code (EDC) circuitry, buffers, cryptographic function blocks, random number generators, entropy sources and conditioners, interface connectors, network adapters, serial ports, power supplies, etc.

A device interface (I/F) logic module 129 provides back end processing and data transfers with a flash memory module 130 coupled to the controller 112. The flash memory module 130 generally corresponds to the memory 104 in FIG. 1 and includes non-volatile memory (NVM) in the form of a flash memory 132 distributed across a plural number N of flash memory dies 134. Flash memory control electronics (not separately shown in FIG. 2) may be provisioned on each die 134 to facilitate parallel data transfer operations via a number of channels (lanes) 136.

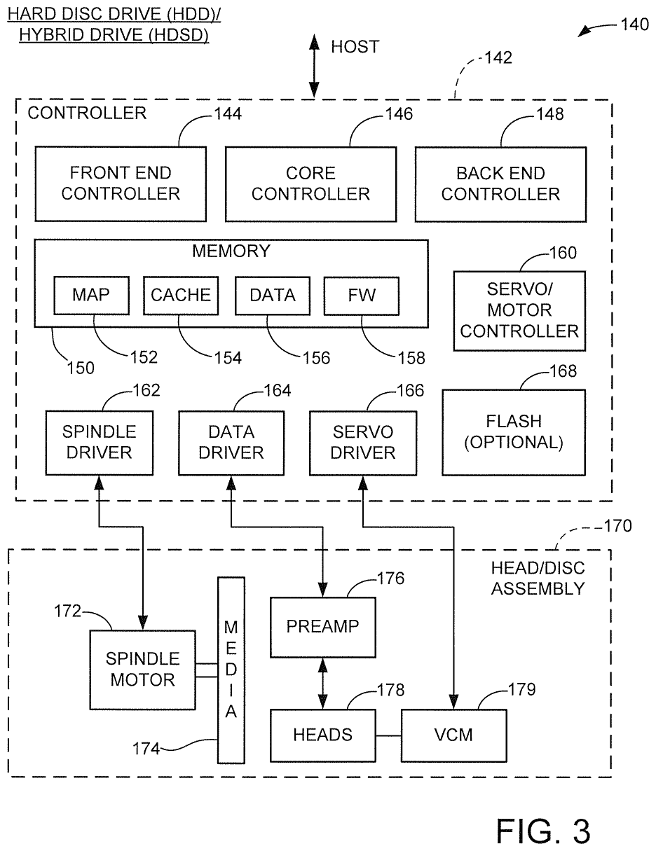

FIG. 3 shows another exemplary data storage device 140 corresponding to the device 100 in FIG. 1. The data storage device 140 in FIG. 3 is characterized as a hard disc drive (HDD) or a hybrid data storage device (HDSD). In this case, the NVM includes rotatable data recording media and, in the case of the hybrid configuration, solid-state flash memory as well.

As with the SSD 110, the device 140 includes a controller 142 with front end, core and back end controllers 144, 146 and 148. Other controller configurations can be used. A memory 150 stores various types of data discussed above including map data 152, cache data 154, user data 156 and firmware (FW) 158.

A servo and motor controller 160 may incorporate the use of an additional processor dedicated to providing closed loop positional control for the device. Various driver circuits are provided including a spindle driver 162, a data driver 164 and a servo driver 166. As desired, optional NAND flash memory 168 can be provided as well.

The controller 142 is coupled to a head/disc assembly (HDA) 170, which generally consolidates certain electro-mechanical aspects of the device 140. The HDA 170 includes a spindle motor 172 that operates responsive to the spindle driver to rotate one or more rotatable data recording media 174, such as magnetic recording discs.

A preamplifier/driver (preamp) circuit 176 communicates with the data driver 164 to pass data and control signals to one or more data read/write transducers (heads) 178. The heads include air bearing surfaces (ABS) that enable the heads to be aerodynamically supported adjacent the rotating media surfaces.

A voice coil motor (VCM) 179 receives power signals from the servo driver 166 to pivotally advance the heads 178 across the media surfaces to enable data to be stored to and retrieved from various tracks. Both the spindle motor 172 and the VCM 179 may be controlled using the servo/motor controller circuit 160.

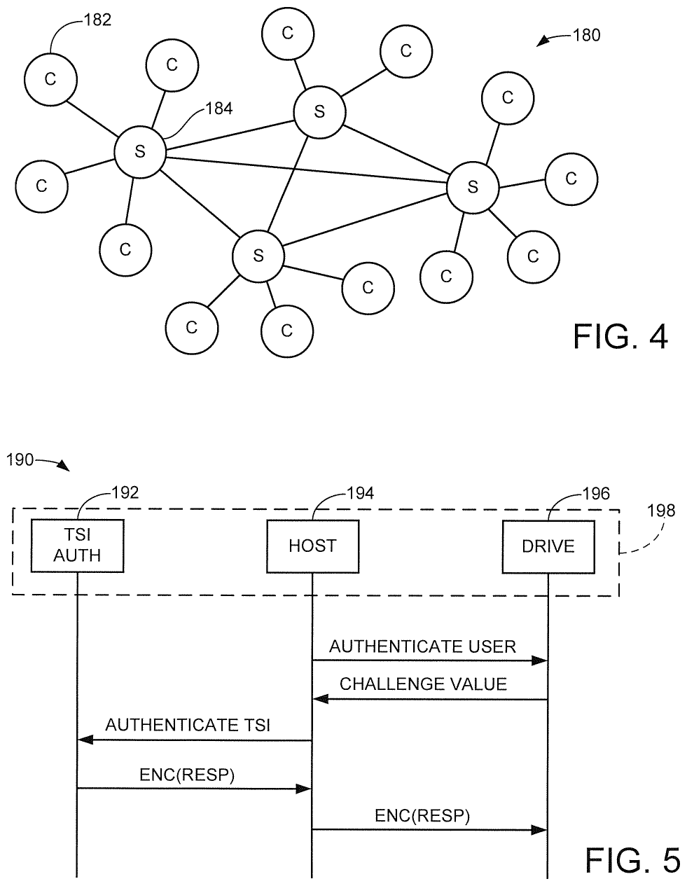

FIG. 4 shows a distributed computer network 180 that can incorporate various processing devices including those of the types discussed above in FIGS. 1-3 The network 180 has a number of interconnected processing nodes including client (C) nodes 182 and server (S) nodes 184. The client nodes may represent local user systems with host computers and one or more storage devices, and the server nodes may interconnect groups of remotely connected clients. Other arrangements can be used. The processing described herein can be carried out by both server and client nodes.

Generally, any node in the system can communicate directly or indirectly with any other node. The network 180 can be a private network, a public network, a cloud computing network, portions of the Internet, etc. It is contemplated that the network 110 may be a low trust environment potentially accessible to attacks by third parties.

FIG. 5 is a sequence diagram 190 illustrating authentication sequence that may be carried out by aspects of the. network 180 in accordance with some embodiments. A trusted security infrastructure (TSI) 192, also sometimes referred to as the TSI authority or the TSI authority circuit, is a logical entity comprised of hardware and/or software designated to handle certain functions within the protection scheme. In some cases the TSI authority 192 may be a separate server dedicated to this purpose, or may be managed and distributed as required among various nodes by authorized system administrators (administrative users). The TSI authority 192 may form a portion of a remote key management system in which system authentication techniques, including the transfer of encryption keys, are passed to provide access to the system.

The diagram in FIG. 5 further includes a host 194 and a drive 196 (e.g., an SSD, HDD, etc.). In this example, the host 194 initiates a sequence to gain authorized access a protected security aspect of the drive 196. In order to do so, sufficient trust must be established between the TSI authority 192, the host 194 and the drive 196. It will be understood that the host may be a computer or other device, and may be operated under the direction of a user such as a human who communicates with the system via the host computer.

To authenticate each of these entities to the others, the host 194 may initiate the process such as by requesting an encrypted challenge string from the drive 196. The host may supply an initial value which is encrypted by the drive, or some other sequence may be employed. The challenge value may be forwarded to the TSI 192, which processes the challenge value in some way to provide an encrypted response, which may be processed by the host and the drive. Trust is established on the basis that valid responses are supplied to inputs using information that, presumably, only a valid and authentic device would be able to successfully provide, such as an embedded secret encryption key, the use of digital signatures, certificates, hash values, and so on.

Once all of the interacting entities are authenticated to each other, the devices 192, 194 and 196 are grouped together within a trust boundary 198, which provides a secure grouping within which the host can proceed with the requested transaction and each entity can securely communicate with the others. Examples that may involve requested transactions may include normal data accesses including accesses to secured volumes, etc. Diagnostic functions may also be enacted such as installing new firmware, performing specific security actions such as secure erasure, drive unlock, enablement of serial ports, etc. Many such inter-entity sequences are known in the art, and substantially any suitable sequence can be used as desired.

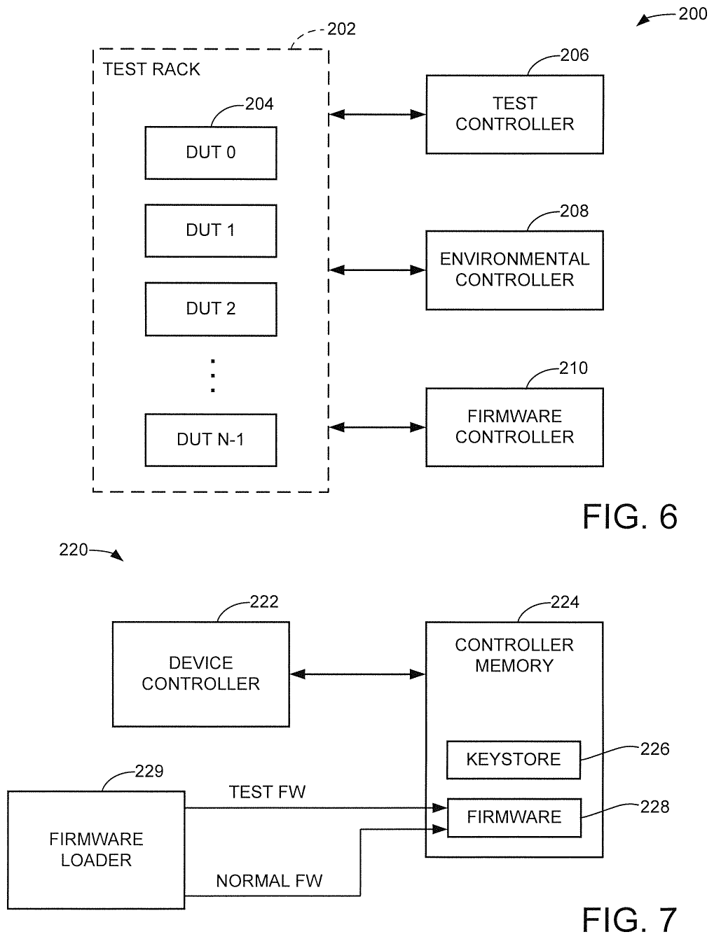

While operable, the system 190 of FIG. 5 is not always suitable for certain types of authentication processing. One such example is provided in FIG. 6 which shows a manufacturing test system 200 constructed and operated in accordance with some embodiments.

The system 200 includes a test rack 202 which houses a population of N devices under test (DUT) 204. The DUTs 204 are contemplated as comprising the various SSDs, HDDs and/or HDSDs presented above in FIGS. 2-3, although the present discussion is not so limited.

The test rack 202 is characterized as an environmental testing chamber with various electrical and environmental elements to enable powered operation of the various DUTs 204 under different environmental conditions such as but not limited to elevated and reduced temperatures, different humidity, different mechanical inputs (vibrations), etc. Various controllers operate the test rack 202 and the DUTs therein including an overall test controller 206, an environmental controller 208 and a firmware controller 210.

In some forms of high volume manufacturing environments, such as but not limited to the production of data storage devices, several millions of DUTs may be concurrently processed on a 24/7 basis to produce potentially hundreds of millions of finished devices annually. The testing carried out may require extended sequences during which all of the relevant functions of the DUTs are evaluated and verified as operational, as well as reliability burn-in processing in an effort to detect and replace elements subject to early-life failures.

In the case of SSD testing, various elements may be evaluated including the operation of the respective controllers, dies, channels, adaptive routines, etc. to ensure the electronic interconnections and circuitry are functional and reliable. In the case of HDD and hybrid device testing, additional testing may take place to ensure the various electro-mechanical elements and connections are operable and reliable. In each of these and other cases, the testing may include the devices being subjected to repetitive power cycling to deactivate and reinitialize the devices. It could potentially be cumbersome to attach the test system 200 to a network such as 180 in FIG. 4 and perform TSI authentication operations such as set forth in FIG. 5 for every DUT for every reinitialization, even if the network and authentication servers were dedicated, in-house units.

Accordingly, some embodiments of the present disclosure configure the various devices to support different trust modes under different operational conditions. FIG. 7 shows another processing device 220 with a processing device controller 222 in communication with a processing device memory 224. The controller and memory may operate as described above and may each be realized as one or more respective physical devices.

The memory includes a keystore 226 and a firmware (FW) store 228. As explained below, the keystore 226 is a specially configured memory location (repository) capable of storing authentication information, referred to herein as an authentication (auth) key. The keystore may comprise a small embedded memory location within a SOC (system on chip) integrated circuit device that also incorporates the device controller 222. Other configurations can be used. The keystore may form a portion of the respective memories 104, 120 and 150 in FIGS. 1-3.

The firmware store 228 represents a repository for the firmware executed by the device controller 222. As such, the firmware store 228 may include a non-volatile location (e.g., in flash memory) and, as desired, a corresponding volatile location (e.g., local DRAM, etc.) to which the firmware, or portions thereof as needed, are loaded during operation.

A firmware loader 229 is further depicted in FIG. 7. The firmware loader may form a portion of the external firmware controller 210 of the manufacturing test system 200 of FIG. 6, or may be an internal aspect of the device as desired. As depicted in FIG. 7, in at least some embodiments the firmware loader 229 loads specially configured test firmware to the firmware store 228 during manufacturing testing.

Once the manufacturing testing is successfully completed, the firmware loader 224 loads normal operational firmware to the firmware store 228 for normal operation of the device controller 222, such as during field use at a customer site. In this embodiment, it is contemplated that the test firmware enacts a untrust mode of operation by the device, and the normal firmware enacts a trust mode of operation by the device.

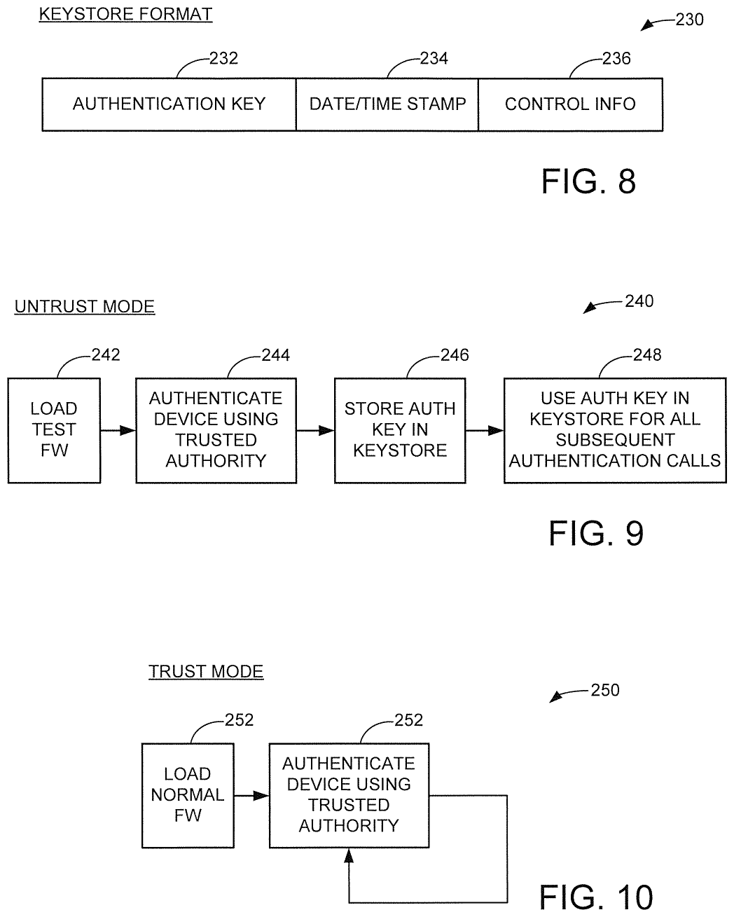

FIG. 8 shows an exemplary format 230 for the contents of the keystore 226 in some embodiments. The format is merely for purposes of illustration and is not limiting, as the authentication information can take any number of suitable forms depending on the requirements of a given application. For clarity, the authentication information is also sometimes referred to herein as self-authentication information or an authentication (auth) key.

The format in FIG. 8 includes an authentication key field 232, a date/time stamp field 234 and a control information field 236. The field 232 includes an authentication key, which may be a value that is expressly used during cryptographic processing such as an encryption/decryption key, a hash input value, a counter value, etc. Regardless of form, the authentication key may be a multi-bit value that, when tested for by the controller as being present in the keystore, signifies the system can continue to operate in the current untrust mode (or in various other modes as discussed below

The field 234 includes a date/time stamp code to signify timing information associated with the authentication key, such as when the key was loaded, etc. In some embodiments, the date/time stamp may additionally or alternatively designate a period of time during which the key is valid, after which further operation in a current mode is prevented. The field 236 provides additional control information that may be used by the system during operation associated with the key.

FIG. 9 shows an untrust mode sequence 240 illustrative of steps that can be carried out in accordance with some embodiments by the systems of FIGS. 6-7. It will be appreciated that the sequence can be carried out concurrently on each of the DUTs 204.

Block 242 shows the loading of appropriate test firmware to a selected DUT, such as by the firmware loader 229. A suitable authentication process is next carried out at block 244 using a trusted authority. This may take place as discussed above in FIG. 5 using a TSI server or similar element.

In the manufacturing environment contemplated in FIG. 6, the TSI server may be a local server coupled via a local network; however, such is not necessarily required as a remote server can be used in a manner similar to, and with the same trust level, as a normal trusted authentication process. Regardless, it will be appreciated that a high trust level is achieved with the trusted authority during this operation.

Block 246 next shows the storage of the authentication (auth) key in the keystore, as discussed above in FIGS. 7-8. This can be carried out in a number of ways. In some embodiments, the test firmware directs the controller to write the appropriate information. In other embodiments, some other element may provide the appropriate information to the keystore.

Finally, block 248 signifies that, during subsequent operation of the test firmware, as executed by the device controller, any function calls or other operations that would normally invoke a network communication with the trusted authority are instead serviced from the keystore. This may include the controller recalling and examining the contents of the keystore to ensure that the contents are valid. If so, the firmware allows the controller to continue on as if a trust boundary exists with the trusted authority, even though no such trust boundary may necessarily be in place.

As noted above, the untrust mode sequence 240 enables operation of the device in a mode in which little or no trust is available. Inputs submitted to the device are not known to be from a known trusted source, and the requested information that the device may output will again be directed to a target entity (e.g., test controller 206, etc.) the trustworthiness of such is unknown. Nevertheless, this type of untrust mode processing is suitable for certain types of operational environments, including but not necessarily limited to manufacturing environments.

FIG. 10 shows a corresponding trust mode sequence 250 to depict operation during a trust mode in some embodiments. As before, this is contemplated as being carried out at the conclusion of e rest sequence, and represents subsequent normal operation by the device.

As shown at block 252, the normal firmware for the device is loaded. This overwrites and supersedes the test firmware. Once loaded, the firmware is executed by the controller. At such times that a trust boundary is required, the firmware directs the controller to authenticate the device using a trusted authority at block 254. As before, this may be carried out including as described in FIG. 5 using a remote TSI authority, although other forms of authentication processing may be carried out as desired.

As noted above, some embodiments contemplate that the entrust mode is used solely during device manufacturing and the trust mode is used solely thereafter during field use. The normal firmware thus does not include any routines that examine or react to the contents of the keystore 226. It follows that the loading of the normal firmware may be sufficient to switch the device to the high trust mode, since there are no inherent capabilities within the normal firmware to do anything other than operate in a normal trust mode.

However, further steps may be taken as required to further ensure device security. In some embodiments, the keystore may be altered, such as by writing all 1s, by opening all of the GTP fuses, by removing other fusible links that isolate the memory portion from further access and use, and so on, once the testing is completed. In this way, even an attack that attempts to upload malicious code (such as the test code, etc.) cannot reasonably or easily result in the device being transitioned back to untrust mode.

Further embodiments can result in the destruction of certain information, such as encryption keys, etc., for data stored on the device when the device cycles between untrust and trust modes (and, as applicable, from trust to untrust modes). While manufacturing testing presents a particularly suitable environment for the use of the untrust mode as described above, it will be appreciated that such is not necessarily limiting; other processing environments, such as normal field use environments, may be suitable for allowing use of the untrust mode.

For example, a secure facility that does not allow interconnection of the storage devices to a separate external network, either permanently or temporarily under specified conditions, may be a suitable environment for enacting the untrust mode as discussed herein. In another example, a portable device such as a phone or tablet with network connectivity (cellular, wireless, Ethernet, etc.) may enable switching between trust and untrust modes based on network availability. Switching to airplane mode can be one instance where the device may have certain features that can continue to operate even if a trusted connection is required. Other processing environments in which the various embodiments presented herein can be advantageously practiced will readily occur to the skilled artisan in view of the present disclosure.

Configuring a device to selectively and repetitively switch among different trust modes can be facilitated by incorporating additional security features, such as the use of different authentication keys and other information, the encryption of such requiring separate decoding by the controller, and so on. Moreover, more than two trust/untrust modes can be enacted such that the security information set forth in the keystore may facilitate, for example, a normal untrust mode and a normal trust mode as described above, as well as additional modes, either higher or lower than these levels, that may require additional levels of trust building in order to facilitate operation.

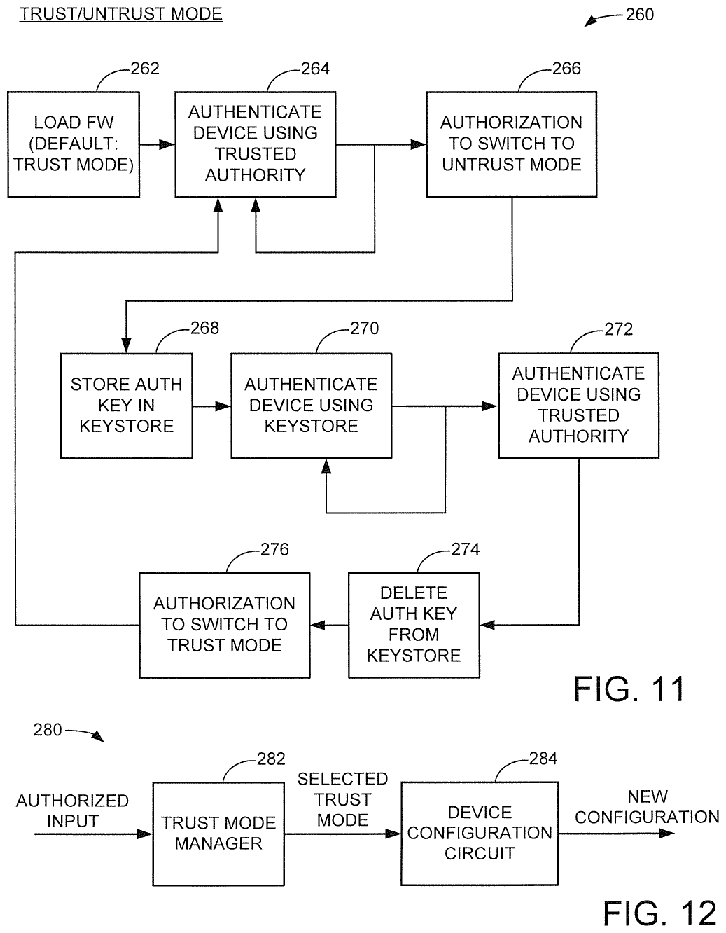

FIG. 11 provides a trust/untrust mode sequence 260 to illustrate an exemplary process flow for a device configured to switch between two different trust modes. The flows are similar to those set forth above except that, as authorized, the device is permitted to repetitively switch between the two modes. It will be noted that both modes may be facilitated by the same set of combined firmware with different operational modules configured to enact different security protocols.

Block 262 begins with the loading of the combined firmware to the device. In the example of FIG. 11, it is contemplated that the default security state is trust mode, although such is not necessarily required. At block 264, an authentication processing sequence is carried out with a trusted authority. It is contemplated that these may be carried out each time required by the firmware as during a normal trust mode. However, at least at some point, including as provided from another trusted source (such as the host in FIG. 5), authorization is provided and confirmed to switch to untrust mode, block 266.

The switch to untrust mode includes the veneration and storage of appropriate authentication key information (as well as other control information) in the keystore, block 268. Thereafter, the firmware operates in untrust mode, including localized (self) authentications of the device using the contents of the keystore, block 270.

At block 272, an indication is supplied such as through a trusted authority to switch back to trusted mode. It will be recognized by the skilled artisan that this potentially presents a problem, since the device is currently operating in an untrust mode. However, there are a number of ways in which this can be enacted, including by configuring the firmware to accept requests to establish a trust boundary with another device.

The process continues at block 274 where the self-authentication information is deleted or otherwise removed from the keystore, and authorization is carried out to switch back to trusted mode, block 276. In this way, the system continues to operate, switching between the untrust/trust modes as required. In some cases, operations or sensors can automatically transition the device from untrust to trust mode; for example, the disconnection of a power or interface cable, the detected movement of the device, a timeout condition, etc. can result in the device shutting down or otherwise not operating further until a trusted connection is made.

FIG. 12 shows another processing device 280 in accordance with further embodiments. The aspects set forth in FIG. 12 can be incorporated into any of the other devices discussed above. The device 280 includes a trust mode manager circuit 282 and a device configuration circuit 284. Generally, the trust mode manager circuit 282 detects various inputs in order to determine which mode in which the device is authorized to operate. In response, the manager circuit 282 establishes the selected trust mode in a manner described above.

In addition, the manager circuit 282 communicates with the device configuration circuit 284, which in turn carries out appropriate configuration changes to the device. The new configuration is established based on the selected trust mode. For example, some features, data accesses, applications, etc. may only be available in a fully trusted mode. Suitable notifications and/or warnings can be displayed on a user API (application program interface such as a touch screen) to signify to the user the current trust status. As noted above, encryption keys used to encrypt user data stored to the NVM of the device may be destroyed to perform a secure erasure of the data upon transitioning from a higher trust mode to a lower trust mode.

Other system configurations can take place as well, such as locking out certain functions, access to certain storage volumes, the reporting of statistics, reliability, configuration and/or usage data, and so on. In this way, certain features or aspects of the device may be enabled to continue to operate in a lower trust environment while other features or aspects may be disabled or inaccessible.

While various embodiments have been presented in the context of various forms of data storage devices such as SSDs, HDDs and hybrid devices, it will be apparent that the present disclosure is not so limited. Any number of different types of processing devices can be used, including but not limited to smart phones, tablets, computers, interconnectivity devices, routing devices, servers, edge computing devices, gaming systems, etc.

Different devices (or grouping of devices) operated in accordance with the NVMe specification as different namespaces by different users can be grouped such that the various namespaces can be operated at different trust levels.

While the trusted authority used to enact or switch among different trust/untrust modes can include local or remote servers or other external devices as described above, such is not limiting. Other forms of trusted authority elements can be used including aspects, operational elements, processors, etc. within the associated processing device itself.

It is to be understood that even though numerous characteristics and advantages of various embodiments of the present disclosure have been set forth in the foregoing description, together with details of the structure and function of various embodiments of the disclosure, this detailed description is illustrative only, and changes may be made in detail, especially in matters of structure and arrangements of parts within the principles of the present disclosure to the full extent indicated by the broad general meaning of the terms in which the appended claims are expressed.

1. A method comprising:
using a trusted authority to establish authentication of a processing device, the processing device being hardware;
storing self-authentication information in a keystore responsive to the authentication; and
subsequently authenticating the processing device using the self-authentication information in the keystore without further reference to the trusted authority.

2. The method of claim 1, wherein the trusted authority is a remote server which communicates with the processing device over a network, the authentication of the processing device establishing a trust boundary that includes at least the remote server and the processing device.

3. The method of claim 1, wherein the using, storing and subsequently authenticating steps are carried out by execution of firmware by a programmable processor of the processing device, the firmware stored in a firmware store of the processing device.

4. The method of claim 3, wherein the firmware is characterized as test firmware used during a manufacturing operation upon the processing device, and the method further comprises subsequently replacing the test firmware with normal firmware used by the programmable processor during field operation of the processing device and removing access, by the programmable processor, to the keystore.

5. The method of claim 1, wherein the using, storing and subsequently authenticating steps by the firmware place the processing device in an untrust mode, and wherein the firmware is further configured to transition the processing device to a trust mode where the trusted authority is used and the keystore is not used to subsequently authenticate the processing device.

6. The method of claim 1, wherein the processing device comprises a programmable processor and memory, the programmable processor incorporated into a system on chip (SOC) integrated circuit device, the keystore comprising an embedded memory location within the SOC.

7. The method of claim 6, wherein the keystore comprises at least one one-time-programmable (OTP) element to store the self-authentication information, and wherein the method further comprises activating the OTP element to render the self-authentication information inaccessible to the programmable processor.

8. The method of claim 1, wherein the processing device is a data storage device comprising a controller and a non-volatile memory (NVM).

9. The method of claim 8, wherein the data storage device comprises a selected one of a solid-state drive (SSD), a hard disc drive (HDD) or a hybrid data storage device (HDSD).

10. A processing device, comprising:
a memory; and
a programmable processor having associated programming stored in the memory and which, when executed, configures the programmable processor to communicate with a trusted authority to perform an authentication operation, to store self-authentication information in a keystore responsive to the authentication operation, and to thereafter operate in an untrust mode by performing self-authentication operations using the self-authentication information in the keystore without further reference to the trusted authority.

11. The processing device of claim 10, wherein the programmable processor operates in an untrust mode during use of the self-authentication information, and wherein the programmable processor subsequently transitions to a trust mode in which the programmable processor performs authentication operations with reference to the trusted authority and without further reference to the keystore.

12. The processing device of claim 10, characterized as a solid-state drive (SSD), the memory comprising NAND flash memory, the keystore comprising embedded memory in a system on chip (SOC) that incorporates the programmable processor.

13. The processing device of claim 10, wherein the memory comprises a rotatable magnetic recording disc.

14. The processing device of claim 10, wherein the keystore comprises non-volatile memory so that the self-authentication information is retained during a power cycle event during which the processing device transitions between a deactivated state and an initialized state.

15. The processing device of claim 10, wherein the keystore comprises volatile memory so that the self-authentication information is automatically lost from the keystore responsive to a power cycle event during which the processing device transitions between a deactivated state and an initialized state.

16. The processing device of claim 10, wherein the trusted authority is a remote server with which the programmable processor communicates over a network, the authentication of the processing device establishing a trust boundary around the remote server and the processing device.

17. The processing device of claim 10, wherein the associated programming comprises specially configured test firmware loaded to the processing device during device manufacturing, and wherein the memory subsequently stores replacement normal firmware that, when executed, configures the programmable processor to perform subsequent authentication operations using the trusted authority and not using the self-authentication information.

18. A system, comprising:
a server; and
a data storage device configured to perform a data exchange with the server over an intervening network to authenticate the data storage device by establishing a trust boundary that includes the server and the data storage device, to store self-authentication information in a keystore of the data storage device responsive to the established trust boundary, and to thereafter operate in an untrust mode by subsequently performing self-authentication operations using the self-authentication information in the keystore.

19. The system of claim 18, wherein the data storage device is further configured to switch from the untrust mode to a trust mode by performing a second data exchange with the server over the intervening network to establish a second trust boundary that includes the server and the data storage device, and to thereafter subsequently re-establish subsequent trust boundaries with the server each time the data storage device performs an authentication operation without use of the keystore.

20. The system of claim 18, wherein the data storage device comprises a controller and an array of data storage devices, the keystore incorporated into a system on chip (SOC) integrated circuit device that also incorporates the controller.
